(19) United States
(12) Patent Application Publication
(10) Pub. No.: US 2017/0184826 A1
(43) Pub. Date: Jun. 29, 2017

(54) ZOOM LENS AND IMAGE DEVICE USING THE SAME

(71) Applicants: NANNING FUGUI PRECISION INDUSTRIAL CO., LTD., Nanning (CN); HON HAI PRECISION INDUSTRY CO., LTD., New Taipei (CN)

(72) Inventor: WEI-CHENG WU, New Taipei (TW)

(21) Appl. No.: 15/070,851

(22) Filed: Mar. 15, 2016

(30) Foreign Application Priority Data
Dec. 28, 2015 (TW) 104143935

(51) Int. Cl. G02B 15/177; G02B 27/00; G02B 13/18

(52) U.S. Cl. CPC G02B 15/177; G02B 13/18; G02B 27/0025

(57) ABSTRACT

A zoom lens includes a first lens group having a negative refractive power, a second lens group having a positive refractive power, a third lens group having a negative refractive power, and an image plane. The first lens group, the second lens group, the third lens group, and the image plane are arranged in that order from an object side to an image side of the zoom lens. The first lens group includes a first lens having a positive refractive power and a second lens having a negative refractive power. The first lens and the second lens are arranged in that order from an object side to an image side. An image device using the zoom lens is also provided.

### FIELD

The subject matter generally relates to a zoom lens and an image device using the zoom lens.

### BACKGROUND

Many electronic devices, such as image devices, include at least one zoom lens. The zoom lens can magnify and obtain a clear image of a reduced field.

### BRIEF DESCRIPTION OF THE DRAWINGS

Implementations of the present technology will now be described, by way of example only, with reference to the attached figures.

FIGS. 1A, 1B, and 1C are isometric views of a zoom lens at a wide-angle end state, in an intermediate state, and at a telephoto end state, respectively.

FIGS. 2A, 2B, and 2C are field curvature graphs of a zoom lens of example 1 at the wide-angle end state, in the intermediate state, and at the telephoto end state, respectively.

FIGS. 3A, 3B, and 3C are distortion graphs of the zoom lens of example 1 at the wide-angle end state, in the intermediate state, and at the telephoto end state, respectively.

FIGS. 4A, 4B, and 4C are lateral chromatic aberration graphs of the zoom lens of example 1 at the wide-angle end state, in the intermediate state, and at the telephoto end state, respectively.

FIGS. 5A, 5B, and 5C are spherical aberration graphs of the zoom lens of example 1 at the wide-angle end state, in the intermediate state, and at the telephoto end state, respectively.

FIGS. 6A, 6B, and 6C are coma aberration graphs of the zoom lens of example 1 at the wide-angle end state, in the intermediate state, and at the telephoto end state, respectively.

FIGS. 7A, 7B, and 7C are field curvature graphs of a zoom lens of example 2 at the wide-angle end state, in an intermediate state, and at the telephoto end state, respectively.

FIGS. 8A, 8B, and 8C are distortion graphs of the zoom lens of example 2 at the wide-angle end state, in an intermediate state, and at the telephoto end state, respectively.

FIGS. 9A, 9B, and 9C are lateral chromatic aberration graphs of the zoom lens of example 2 at the wide-angle end state, in the intermediate state, and at the telephoto end state, respectively.

FIGS. 10A, 10B, and 10C are spherical aberration graphs of the zoom lens of example 2 at the wide-angle end state, in the intermediate state, and at the telephoto end state, respectively.

FIGS. 11A, 11B, and 11C are coma aberration graphs of the zoom lens of example 2 at the wide-angle end state, in the intermediate state, and at the telephoto end state, respectively.

FIGS. 12A, 12B, and 12C are field curvature graphs of a zoom lens of example 3 at the wide-angle end state, in the intermediate state, and at the telephoto end state, respectively.

FIGS. 13A, 13B, and 13C are distortion graphs of the zoom lens of example 3 at the wide-angle end state, in the intermediate state, and at the telephoto end state, respectively.

FIGS. 14A, 14B, and 14C are lateral chromatic aberration graphs of the zoom lens of example 3 at the wide-angle end state, in the intermediate state, and at the telephoto end state, respectively.

FIGS. 15A, 15B, and 15C are spherical aberration graphs of the zoom lens of example 3 at the wide-angle end state, in the intermediate state, and at the telephoto end state, respectively.

FIGS. 16A, 16B, and 16C are coma aberration graphs of the zoom lens of example 3 at the wide-angle end state, in the intermediate state, and at the telephoto end state, respectively.

FIG. 17 is an isometric view of an image device according to an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like.

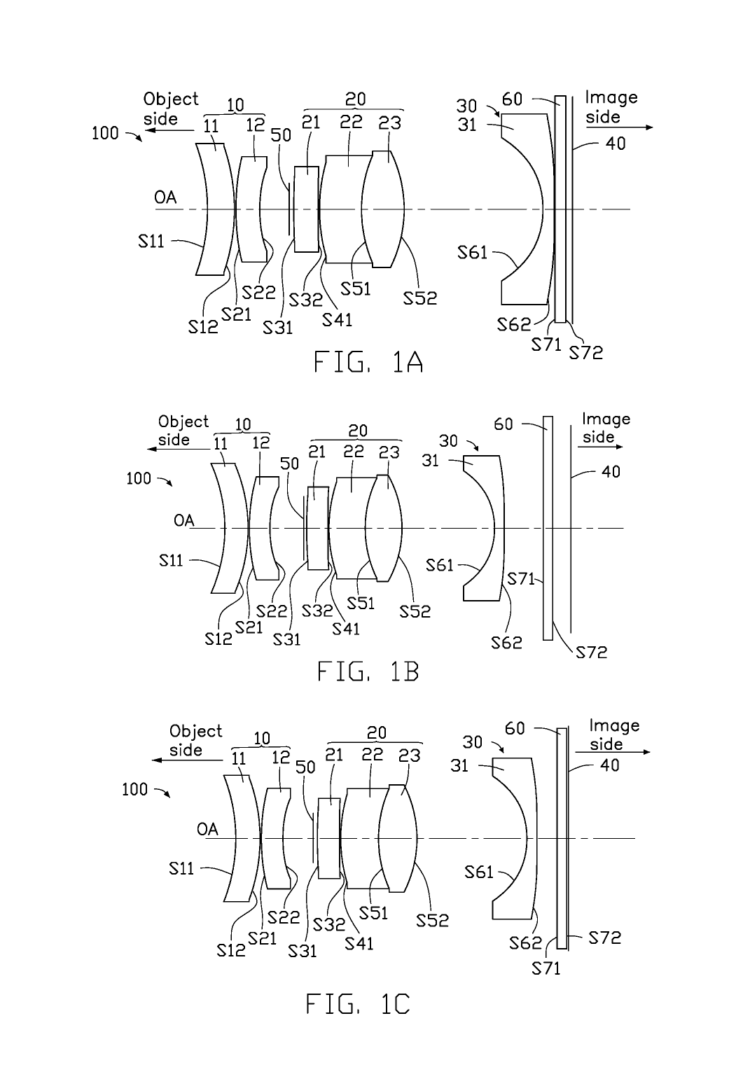

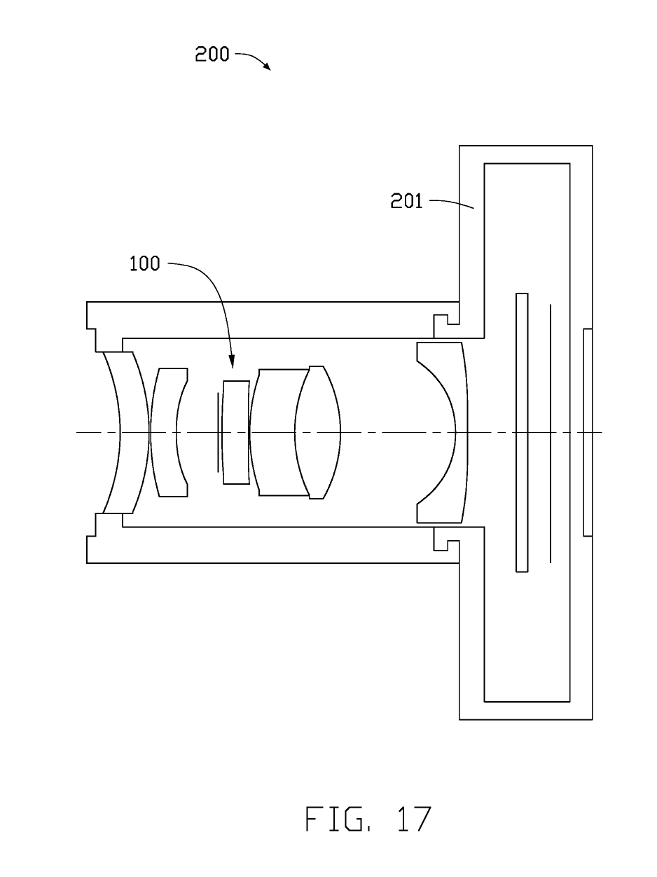

FIGS. 1A, 1B, and 1C illustrate an embodiment of a zoom lens 100 used in an image device 200 (shown in the FIG. 17). The zoom lens 100 comprises a first lens group 10 having a negative refractive power, a second lens group 20 having a positive refractive power, a third lens group 30 having a negative refractive power, and an image plane 40. The first lens group 10, the second lens group 20, the third lens group 30, and the image plane 40 are arranged in that order from object side to image side of the zoom lens 100 as shown in FIGS. 1A, 1B, and 1C. The first lens group 10, the second lens group 20, and the third lens group 30 have a same optical axis OA. When zooming from a wide-angle end to a telephoto end, the first lens group 10, the second lens group 20, and the third lens group 30 are moved toward the object side along the optical axis OA.

The first lens group 10 comprises a first lens 11 having a positive refractive power, and a second lens 12 having a negative refractive power. The first lens 11 and the second lens 12 are arranged in the order from the object side to the image side. The second lens group 20 comprises a third lens 21 having a positive refractive power, a fourth lens 22 having a negative refractive power, and a fifth lens 23 having a positive refractive power. The fourth lens 22 and the fifth lens 23 are fixed together to form a cemented lens. The third lens 21, the fourth lens 22, and the fifth lens 23 are arranged in the order from the object side to the image side. The third lens group 30 comprises a sixth lens 31 having a negative refractive power.

The zoom lens 100 satisfies the following formulas, (1), (2), and (3):

θ_{w}/TTL>8; (1)

|FG1/f_{w}≧|4; (2)

|f₁/f₂|≧8.5. (3)

Wherein θ_{w} represents a field of view (FOV) of the zoom lens 100 at the wide-angle end state, TTL represents a total distance from the object side of the zoom lens 100 to the image plane 40 along the optical axis OA, FG1 represents a focal length of the first lens group 10, and f_{w} represents a focal length of the zoom lens 100 at the wide-angle end state. The formulas θ_{w}/TTL>8 and |FG1/f_{w}|≧4 enable the zoom lens 100 to have a relatively large visual angle in case of a minimized image field. The formula |f₁/f₂|≧8.5 controls a magnification and a correction aberration of the zoom lens 100.

In order to reduce the TTL of the zoom lens 100 to achieve miniaturization, and improve the FOV and zoom ratio of the zoom lens 100 to improve image quality, the zoom lens 100 further satisfies the following formulas, (4) and (5):

|N_{d}4−N_{d}5|>0.25; (4)

0.65<|f₄/V₄+f₅/V₅|<0.75. (5)

Wherein N_{d}4 represents a refractive index of the fourth lens 22, N_{d}5 represents a refractive index of the fifth lens 23, f₄ represents a focal length of the fourth lens 22, f₅ represents a focal length of the fifth lens 23, V₄ represents an Abbe number of the fourth lens 22, and V₅ represents an Abbe number of the fifth lens 23.

The zoom lens 100 further satisfies the following formulas, (6) and (7):

1.9≦|(FG2−MG3)/FG3|≦2.3; (6)

0.28≦|FG2/f_{T}|≦0.33. (7)

Wherein FG2 represents a focal length of the second lens group 20, MG3 represents a moving distance of third lens group 30 moving from the wide-angle end to the telephoto end along the optical axis OA, FG3 represents a focal length of the third lens group 30, and f_{T} represents a focal length of the zoom lens 100 at the telephoto end state.

At least one of the lens of the first lens group 10 is made of plastic. At least one of the lens of the second lens group 20 is made of plastic. At least one of the lens of the third lens group 30 is made of plastic. Lenses being made of plastic effectively reduce the weight of the zoom lens 100. In at least one embodiment, the second lens 12, the third lens 21, and the sixth lens 31 are made of plastic, while the first lens 11, the fourth lens 22, and the fifth lens 23 are made of glass.

The zoom lens 100 further comprises an aperture 50, a plane lens 60, an image capturing unit (not shown), and a filter (not shown).

The aperture 50 is located between the first lens group 10 and the second lens group 20. The optical center of the aperture 50 is on the optical axis OA. The aperture 50 is configured to limit light into the second lens group 20. Light beams passed through the aperture 50 are more symmetrical. The aperture 50 can move along the optical axis OA with the second lens group 20.

The plane lens 60 is located between the third lens group 30 and the image plane 40. The plane lens 60 is a glass cover protecting the image capturing unit. In at least one embodiment, the plane lens does not have optical effect.

The image capturing unit is secured to the image plane 40. The image capturing unit has a function of photoelectric conversion. The image capturing unit can receive light beams from the filter.

The filter is located between the third lens group 30 and the plane lens 60. The filter is configured to filter out non-visible light. The filter may be a low pass filter, an infrared cut-off filter or the like.

In the following description, the shape (spherical or aspherical) of a lens element surface is defined from the point of view of the object side or of the image side. The first lens 11 comprises a first surface S11 facing the object side, and a second surface S12 facing the image side. The second lens 12 comprises a third surface S21 facing the object side, and a fourth side S22 facing the image side. At least one of the first surface S11, the second surface S12, the third surface S21, and the fourth side S22 is an aspherical surface. In other words, the first lens group 10 comprises at least one aspherical surface.

The third lens 21 comprises a fifth surface S31 facing the object side, and a sixth surface S32 facing the image side. The fourth lens 22 comprises a seventh surface S41 facing the object side. The fifth lens 23 comprises a ninth surface S52 facing the image side. The fourth lens 22 and the fifth lens 23 are bonded together to have a common eighth surface S51 sandwiched between the fourth lens 22 and the fifth lens 23. Thus eighth surface S51 is a cemented surface. At least one of the fifth surface S31, the sixth surface S32, the seventh surface S41, the eighth surface S51, and the ninth surface S52 is an aspherical surface. In other words, the second lens group 20 comprises at least one aspherical surface.

The sixth lens 31 comprises a tenth surface S61 facing the object side, and an eleventh surface S62 facing the image side. At least one of the tenth surface S61 and the eleventh surface S62 is an aspherical surface. In other words, the third lens group 30 comprises at least one aspherical surface.

The plane lens 60 comprises a twelfth surface S71 facing the object side, and a thirteenth surface S72 facing the image side.

The aspherical surface satisfies the following formula, (formula 8):

$$z = \frac{{ch}^{2}}{1 + \sqrt{1 - ( k + 1 ) {c}^{2} {h}^{2}}} + {E}_{4} {h}^{4} + {E}_{6} {h}^{6} + {E}_{8} {h}^{8} + {E}_{10} {h}^{10} . \qquad ( 8 )$$

Wherein, Z represents a coordinate on the optical axis OA; c=1/R, and the R represents a paraxial radius of curvature (radius of curvature of the reference spherical surface); h represents a coordinate along a direction orthogonal to the optical axis OA; k represents a conical coefficient; E₄, E₆, E₈, and E₁₀ represent aspherical coefficients. Each parameter value or coefficient value of the two aspherical surfaces of each aspherical lens can be set separately, thereby determining the focal length of the aspherical lens.

In at least one embodiment, the first surface S11 is a concave surface facing the object side, the second surface S12 is a convex surface facing the image side, the third surface S21 is a convex surface facing the object side, the fourth surface S22 is a concave surface facing the image side, the fifth surface S31 is a plane surface facing the object side, the sixth surface S32 is a plane surface facing the image side, the seventh surface S41 is a convex surface facing the object side, the eighth surface S51 is not only a concave surface of the fourth lens 22 facing the image side, but also a convex surface of the fifth lens 23 facing the object side, and the ninth surface S52 is a convex surface facing the image side. In at least one embodiment, the fifth lens 23 is a biconvex lens.

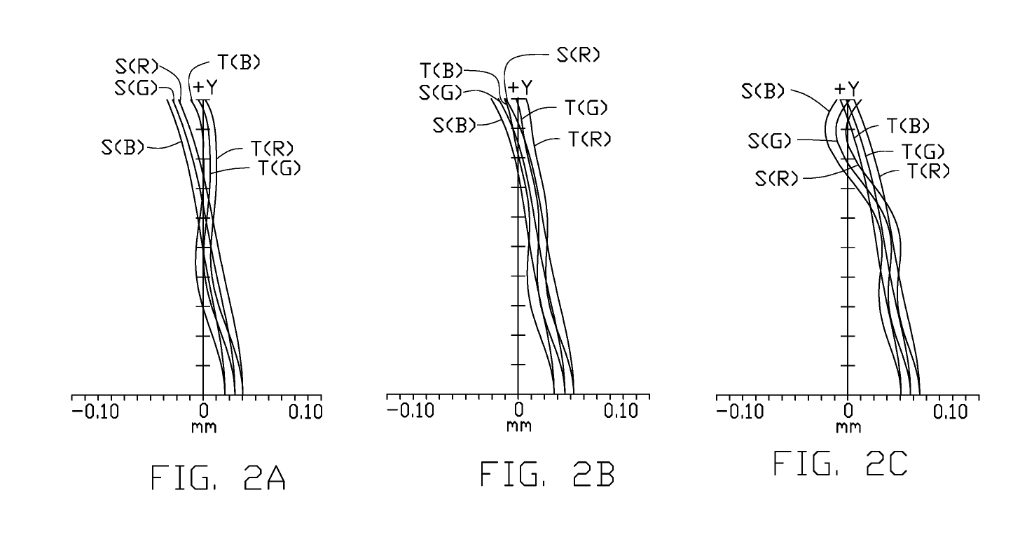

Referring to FIG. 2A to FIG. 16C, in the following examples 1 to 3, the third surface S21 and the fourth surface S22 of the second lens 12 are aspherical surfaces, the fifth surface S31 and the sixth surface S32 of the third lens 21 are aspherical surfaces, and the tenth surface S61 and the eleventh surface S62 of the sixth lens 31 are aspherical surfaces. In other words, the second lens 12, the third lens 21, and the sixth lens 31 are aspherical lenses. D1 represents distance between the first lens group 10 and the second lens group 20 along the optical axis OA and D2 represents distance between the second lens group 20 and the third lens group 30 along the optical axis OA. D3 represents distance between the third lens group 30 and the plane lens 60 along the optical axis OA. The wavelength of blue light (B) is 0.4358 jam, the wavelength of green light (G) is 0.5461 jam, and the wavelength of red light (R) is 0.6563 am. T represents an aberration of the zoom lens 100 in respect of tangential rays. S represents an aberration of the zoom lens 100 for sagittal rays.

### Example 1

The focal length f_{w} of the zoom lens 100 at the wide-angle end state is 4.3 mm, the focal length fₘ of the zoom lens 100 in the intermediate is 6.69 mm, and the focal length f_{T} of the zoom lens 100 at the telephoto end state is 12.91 mm. The relative aperture of the zoom lens 100 has a range from about 2.2 to about 4.25. Table 1 lists R (radius of curvature), thickness, refractive index, and Abbe number of each lens and aperture 50. Table 2 lists the quadratic surface constant k and aspherical coefficients E₄, E₆, E₈ and E₁₀ of each aspherical surface. Table 3 lists D1, D2, and D3.

TABLE 1

| | R | Thickness | Refractive | Abbe |
|---|---|---|---|---|
| Surface | (mm) | (mm) | index | number |
| S11 | −5.2189 | 0.6969 | 1.816000 | 46.42 |
| S12 | −5.3439 | 0.0413 | 1.000000 | — |
| S21 | 7.0622 | 0.6264 | 1.635050 | 23.90 |
| S22 | 4.1753 | D1 | 1.000000 | — |
| Aperture 50 | ∞ | 0.0980 | 1.000000 | — |
| S31 | 29.0481 | 0.6852 | 1.491756 | 57.44 |
| S32 | −36.3542 | 0.0369 | 1.000000 | — |
| S41 | 4.9724 | 1.1677 | 1.846663 | 23.83 |
| S51 | 3.3108 | 1.1860 | 1.571000 | 64.20 |
| S52 | −3.6721 | D2 | 1.000000 | — |
| S61 | −2.5927 | 0.3293 | 1.491756 | 57.44 |
| S62 | 0.8710 | D3 | 1.000000 | — |
| S71 | ∞ | 0.3000 | 1.516330 | 64.14 |
| S72 | ∞ | 0.0500 | 1.000000 | — |

TABLE 2

| Surface | k | E₄ | E₆ | E₈ | E₁₀ |
|---|---|---|---|---|---|
| S21 | 0 | 5.503e⁻³ | −7.331e⁻⁴ | −9.658e⁻⁵ | 2.667e⁻⁶ |
| S22 | −0.048856 | 1.646e⁻² | 1.862e⁻⁴ | 9.376e⁻⁵ | −3.275e⁻⁵ |
| S31 | 32.89186 | 1.032e⁻² | 6.208e⁻⁴ | 3.862e⁻⁵ | — |
| S32 | −1.96e⁺³⁹ | 5.934e⁻³ | 6.484e⁻⁴ | 3.439e⁻⁶ | 2.358e⁻⁵ |
| S61 | −0.310035 | −1.459e⁻² | −2.838e⁻³ | 1.039e⁻³ | −1.170e⁻⁴ |
| S62 | −3.11e⁺³⁹ | −90496e⁻³ | 1.043e⁻³ | −3.695e⁻⁵ | — |

TABLE 3

| State | D1 | D2 | D3 |
|---|---|---|---|
| Wide-angle end state (mm) | 0.8797 | 3.8734 | 0.0200 |
| Intermediate state (mm) | 1.0107 | 3.3943 | 0.6362 |
| Telephoto end state (mm) | 1.1306 | 2.9837 | 1.2827 |

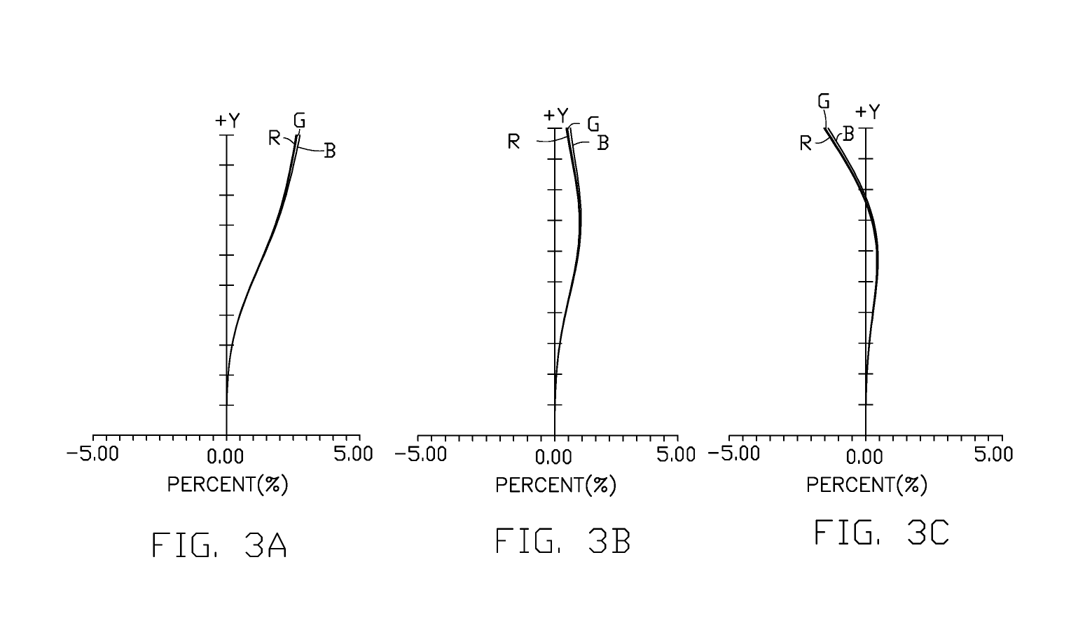

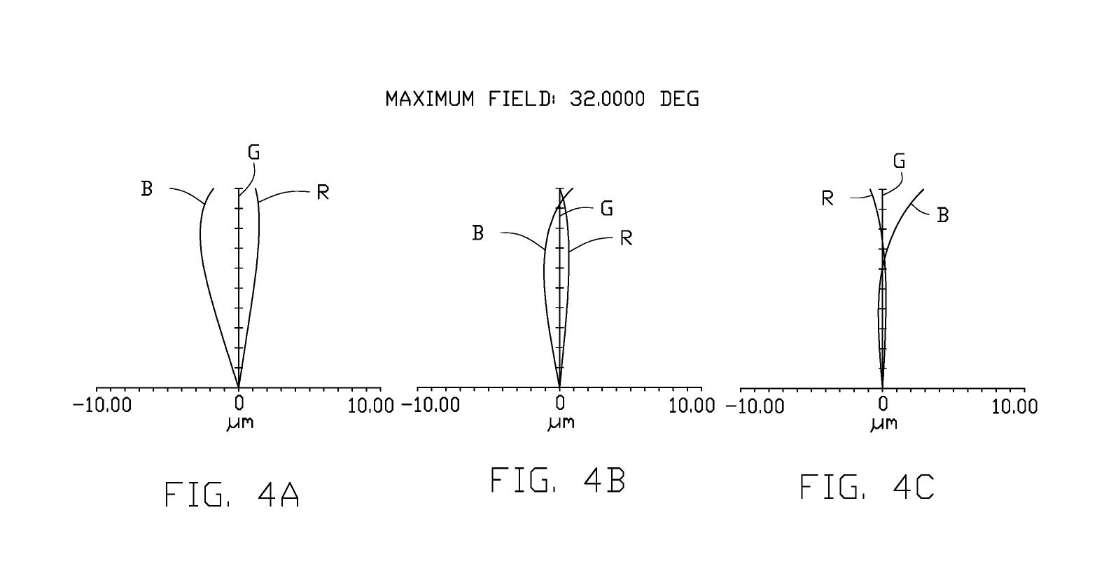

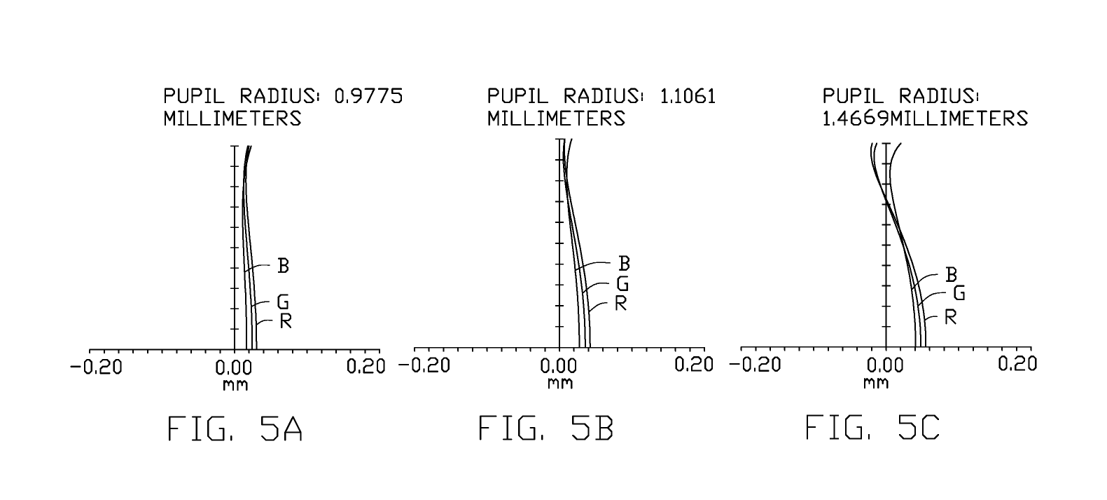

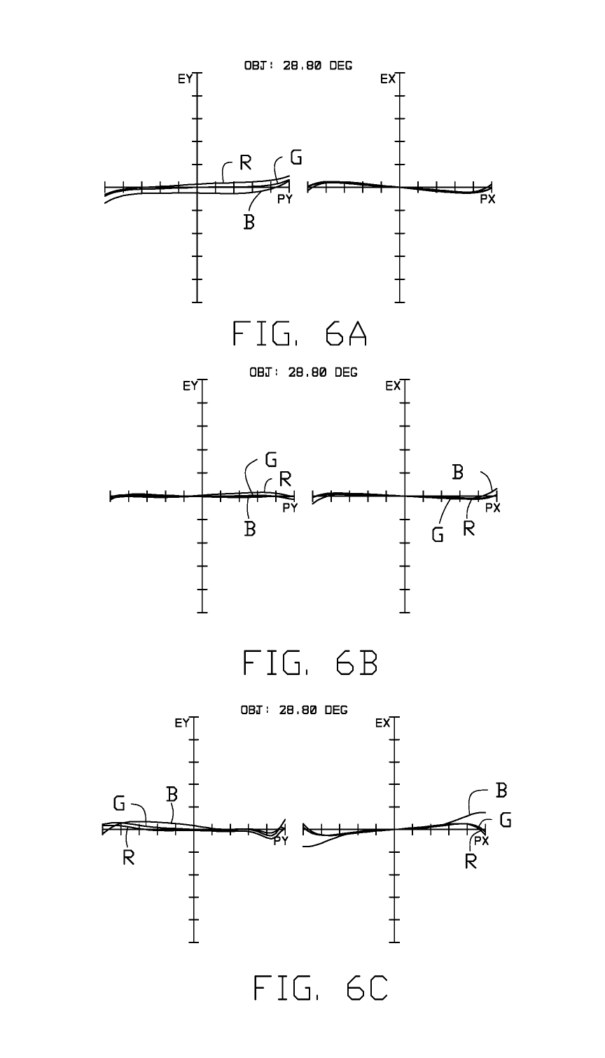

In example 1, the field curvature of the blue light, the green light, and the red light at the wide-angle end state, in the intermediate state, and at the telephoto end state are respectively shown in the FIGS. 2A, 2B, and 2C. The respective distortions of the blue light, the green light, and the red light at the wide-angle end state, in the intermediate state, and at the telephoto end state are respectively shown in the FIGS. 3A, 3B, and 3C. The respective lateral chromatic aberrations of the blue light, the green light, and the red light at the wide-angle end state, in the intermediate state, and at the telephoto end state are respectively shown in the FIGS. 4A, 4B, and 4C. The respective spherical aberrations of the blue light, the green light, and the red light at the wide-angle end state, in the intermediate state, and at the telephoto end state are respectively shown in the FIGS. 5A, 5B, and 5C. The respective coma aberrations of the blue light, the green light, and the red light at the wide-angle end state, in the intermediate state, and at the telephoto end state are respectively shown in the FIGS. 6A, 6B, and 6C.

Referring to FIG. 2A, the highest field curvature of the zoom lens 100 at the wide-angle end state is in a range from about −0.028 mm to about 0.029 mm. Referring to FIG. 3A, the highest distortion of the zoom lens 100 at the wide-angle end state is no more than 2.2%. Referring to FIG. 4A, the highest lateral chromatic aberration of the zoom lens 100 at the wide-angle end state is no more than 2.8 am. Referring to FIG. 5A, the highest spherical aberration of the zoom lens 100 at the wide-angle end state is in a range from about 0.028 mm to about 0.09 mm. Referring to FIG. 6A, the coma aberration of the zoom lens 100 at the wide-angle end state is acceptable.

Referring to FIG. 2B, the highest field curvature of the zoom lens 100 in the intermediate state is in a range from about 0.026 mm to about 0.041 mm. Referring to FIG. 3B, the highest distortion of the zoom lens 100 in the intermediate state is no more than 0.71%. Referring to FIG. 4B, the highest lateral chromatic aberration of the zoom lens 100 in the intermediate state is no more than 1.2 am. Referring to FIG. 5B, the highest spherical aberration of the zoom lens 100 in the intermediate state is in a range from about 0.005 mm to about 0.041 mm. Referring to FIG. 6B, the coma aberration of the zoom lens 100 in the intermediate state is acceptable.

Referring to FIG. 2C, the highest curvature of the zoom lens 100 at the telephoto end state is in a range from about −0.02 mm to about 0.052 mm. Referring to FIG. 3C, the highest distortion of the zoom lens 100 at the telephoto end state is no more than −2.1%. Referring to FIG. 4C, the highest lateral chromatic aberration of the zoom lens 100 at the telephoto end state is no more than 2.8 am. Referring to FIG. 5C, the highest spherical aberration of the zoom lens 100 at the telephoto end state is in a range from about −0.021 mm to about 0.052 mm. Referring to FIG. 6C, the coma aberration of the zoom lens 100 at the telephoto end state is acceptable.

### Example 2

The focal length f_{w} of the zoom lens 100 at the wide-angle end state is 4.3 mm, the focal length fₘ of the zoom lens 100 in the intermediate is 6.47 mm, the focal length f_{T} of the zoom lens 100 at the telephoto end state is 12.91 mm, and the relative aperture of the zoom lens 100 has a range from about 2.2 to about 4.35. Table 4 lists R (radius of curvature), thickness, refractive index, and Abbe number of each lens and aperture 50. Table 5 lists the quadratic surface constant k and aspherical coefficient E₄, E₆, E₈ and E₁₀ of each aspherical surface. Table 6 lists D1, D2, and D3.

TABLE 4

| | R | Thickness | Refractive | Abbe |
|---|---|---|---|---|
| Surface | (mm) | (mm) | index | number |
| S11 | −4.5029 | 0.8163 | 1.816000 | 46.42 |
| S12 | −407.42 | 0.0379 | 1.000000 | — |
| S21 | 8.1036 | 0.4918 | 1.635050 | 23.90 |
| S22 | 4.5519 | D1 | 1.000000 | — |
| Aperture 50 | ∞ | 0.0980 | 1.000000 | — |
| S31 | 17.9042 | 0.6899 | 1.491756 | 57.44 |
| S32 | −36.7309 | 0.0390 | 1.000000 | — |
| S41 | 4.6437 | 1.1743 | 1.846663 | 23.83 |
| S51 | 3.0694 | 1.1890 | 1.571000 | 64.20 |
| S52 | −4.4720 | D2 | 1.000000 | — |
| S61 | −2.7545 | 0.3565 | 1.491756 | 57.44 |
| S62 | 0.8983 | D3 | 1.000000 | — |
| S71 | ∞ | 0.3000 | 1.516330 | 64.14 |
| S72 | ∞ | 0.0500 | 1.000000 | — |

TABLE 5

| Surface | k | E₄ | E₆ | E₈ | E₁₀ |
|---|---|---|---|---|---|
| S21 | 0 | −1.663e⁻³ | −1.037e⁻² | 1.256e⁻⁴ | −1.484e⁻⁵ |
| S22 | −4.20327 | 1.071e⁻² | −1.149e⁻³ | 3.465e⁻⁴ | −5.202e⁻⁵ |
| S31 | −26.17223 | 9.117e⁻³ | 6.441e⁻⁴ | 2.204e⁻⁵ | — |
| S32 | −1.96e⁺³⁹ | 5.002e⁻³ | 7.101e⁻⁴ | −3.562e⁻⁶ | 1.877e⁻⁵ |
| S61 | 0.7385943 | −1.541e⁻² | −2.502e⁻³ | 8.309e⁻⁴ | −9.279e⁻⁵ |
| S62 | −3.13e⁺³⁹ | −8.769e⁻³ | 9.528e⁻⁴ | −3.224e⁻⁵ | — |

TABLE 6

| State | D1 | D2 | D3 |
|---|---|---|---|
| Wide-angle end state (mm) | 0.8096 | 3.9219 | 0.0200 |
| Intermediate state (mm) | 0.9661 | 3.4407 | 0.6246 |
| Telephoto end state (mm) | 1.1276 | 2.9724 | 1.3353 |

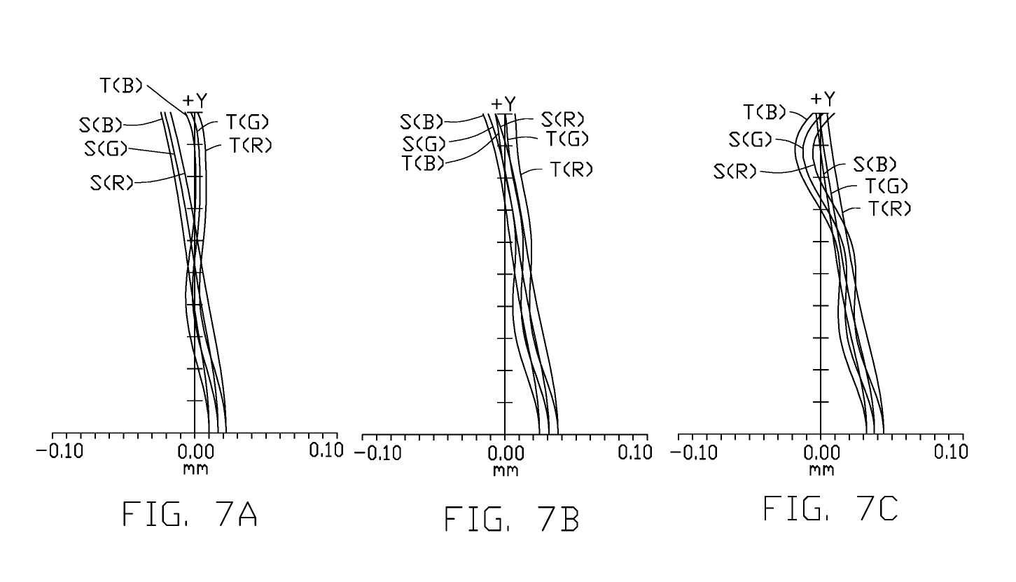

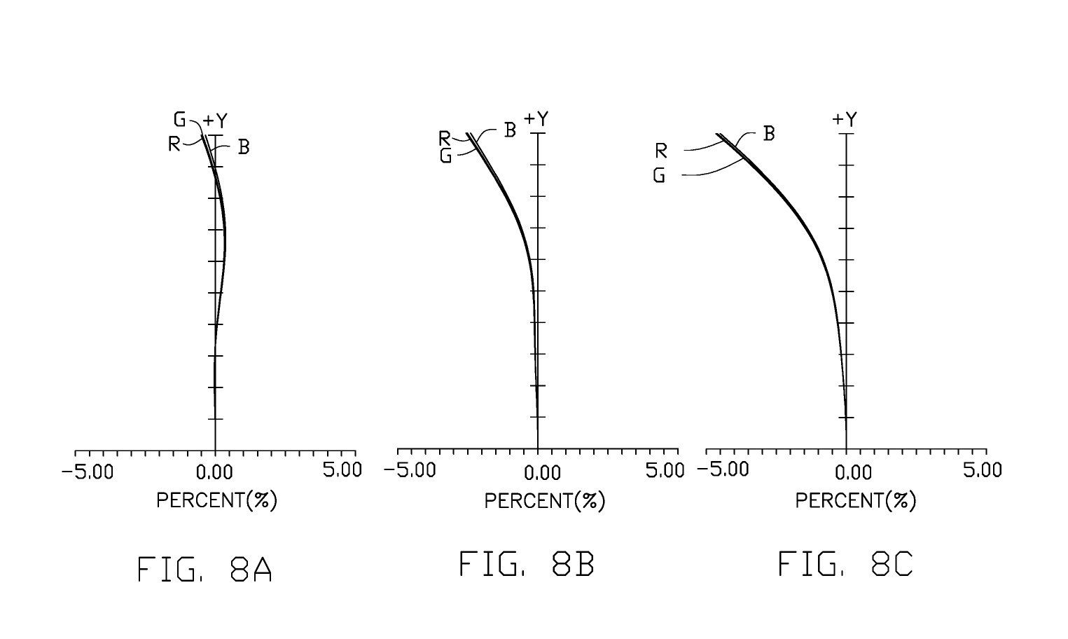

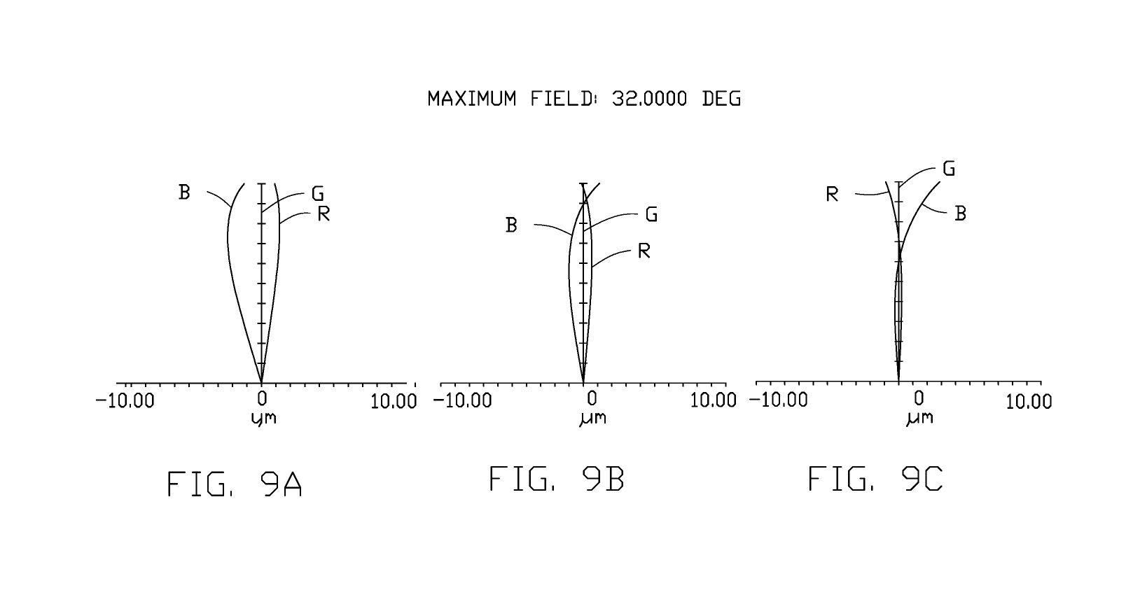

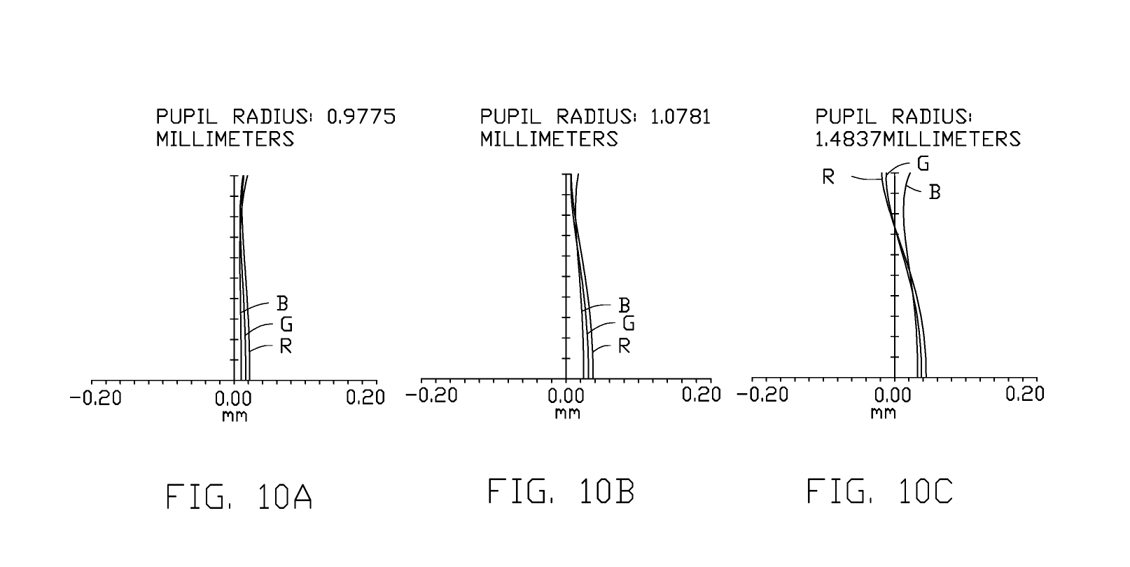

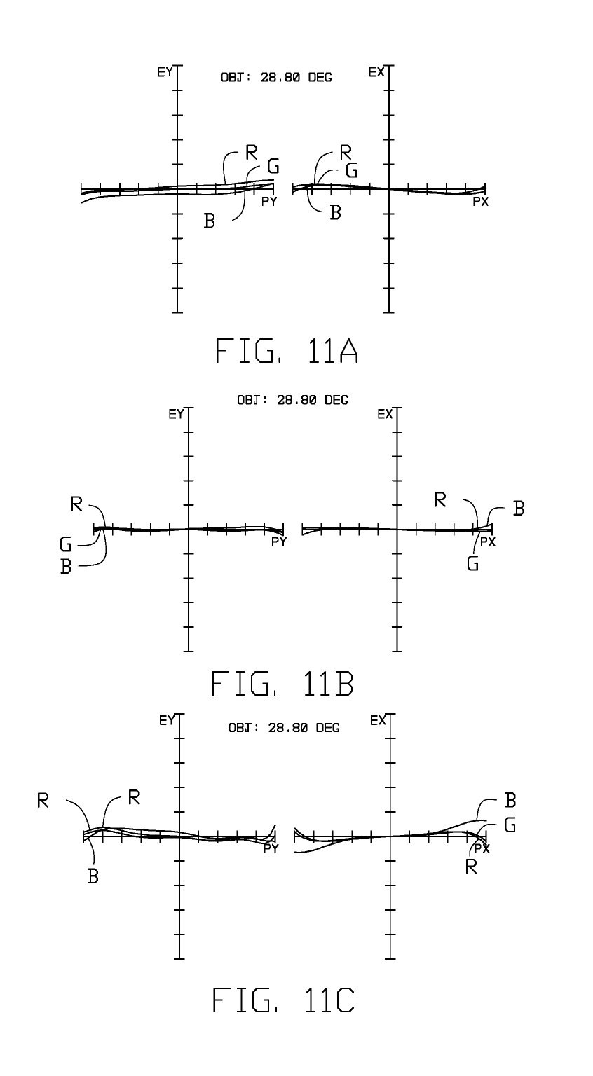

In example 2, the respective field curvatures of the blue light, the green light, and the red light at the wide-angle end state, in the intermediate state, and at the telephoto end state are respectively shown in the FIGS. 7A, 7B, and 7C. Respective distortions of the blue light, the green light, and the red light at the wide-angle end state, in the intermediate state, and at the telephoto end state are respectively shown in the FIGS. 8A, 8B, and 8C. The respective lateral chromatic aberrations of the blue light, the green light, and the red light at the wide-angle end state, in the intermediate state, and at the telephoto end state are respectively shown in the FIGS. 9A, 9B, and 9C. The respective spherical aberrations of the blue light, the green light, and the red light at the wide-angle end state, in the intermediate state, and at the telephoto end state are respectively shown in the FIGS. 10A, 10B, and 10C. The respective coma aberration of the blue light, the green light, and the red light at the wide-angle end state, in the intermediate state, and at the telephoto end state are respectively shown in the FIGS. 11A, 11B, and 11C.

Referring to FIG. 7A, the highest field curvature of the zoom lens 100 at the wide-angle send is in a range from about −0.024 mm to about 0.022 mm. Referring to FIG. 8A, the highest distortion of the zoom lens 100 at the wide-angle end state is no more than −0.52%. Referring to FIG. 9A, the highest lateral chromatic aberration of the zoom lens 100 at the wide-angle end state is no more than 2.4 am. Referring to FIG. 10A, the highest spherical aberration of the zoom lens 100 at the wide-angle end state is in a range from about 0.008 mm to about 0.022 mm. Referring to FIG. 11A, the coma aberration of the zoom lens 100 at the wide-angle end state is acceptable.

Referring to FIG. 7B, the highest field curvature of the zoom lens 100 in the intermediate state is in a range from about −0.016 mm to about 0.038 mm. Referring to FIG. 8B, the highest distortion of the zoom lens 100 in the intermediate state is no more than −2.56%. Referring to FIG. 9B, the highest lateral chromatic aberration of the zoom lens 100 in the intermediate state is no more than 1.2 m. Referring to FIG. 10B, the highest spherical aberration of the zoom lens 100 in the intermediate state is in a range from about 0.006 mm to about 0.038 mm. Referring to FIG. 11B, the coma aberration of the zoom lens 100 in the intermediate state is acceptable.

Referring to FIG. 7C, the highest field curvature of the zoom lens 100 at the telephoto end state is in a range from about −0.019 mm to about 0.045 mm. Referring to FIG. 8C, the highest distortion of the zoom lens 100 at the telephoto end state is no more than −4.66%. Referring to FIG. 9C, the highest lateral chromatic aberration of the zoom lens 100 at the telephoto end state is no more than 2.9 m. Referring to FIG. 10C, the highest spherical aberration of the zoom lens 100 at the telephoto end state is in a range from about −0.019 mm to about 0.045 mm. Referring to FIG. 11C, the coma aberration of the zoom lens 100 at the telephoto end state is acceptable.

### Example 3

The focal length f_{w} of the zoom lens 100 at the wide-angle end state is 4.24 mm, the focal length fₘ of the zoom lens 100 in the intermediate is 6.27 mm, the focal length f_{T} of the zoom lens 100 at the telephoto end state is 12.91 mm, and the relative aperture of the zoom lens 100 has a range from about 2.2 to about 4.3. Table 7 lists R (radius of curvature), thickness, refractive index, and Abbe number of each lens and aperture 50. Table 8 lists the quadratic surface constant k and aspherical coefficient E₄, E₆, E₈ and E₁₀ of each aspherical surface. Table 9 lists D1, D2, and D3.

TABLE 7

| | R | Thickness | Refractive | Abbe |
|---|---|---|---|---|
| Surface | (mm) | (mm) | index | number |
| S11 | −4.6917 | 1.0985 | 1.816000 | 46.42 |
| S12 | −4.9840 | 0.2171 | 1.000000 | — |
| S21 | 11.4702 | 0.4939 | 1.635050 | 23.90 |
| S22 | 5.4228 | D1 | 1.000000 | — |
| Aperture 50 | ∞ | 0.0980 | 1.000000 | — |
| S31 | 12.9244 | 0.6864 | 1.491756 | 57.44 |
| S32 | −34.9090 | 0.0477 | 1.000000 | — |
| S41 | 5.0299 | 1.1466 | 1.846663 | 23.83 |
| S51 | 3.4503 | 1.1859 | 1.571000 | 64.20 |
| S52 | −4.7753 | D2 | 1.000000 | — |
| S61 | −2.8391 | 0.3160 | 1.491756 | 57.44 |
| S62 | 0.8319 | D3 | 1.000000 | — |
| S71 | ∞ | 0.3000 | 1.516330 | 64.14 |
| S72 | ∞ | 0.0500 | 1.000000 | — |

TABLE 8

| Surface | k | E₄ | E₆ | E₈ | E₁₀ |
|---|---|---|---|---|---|
| S21 | 0 | −1.17e⁻² | 3.617e⁻⁴ | 2.310e⁻⁴ | −2.297e⁻⁵ |
| S22 | −6.0870 | −0.009449 | 2.711e⁻⁴ | 3.729e⁻⁴ | −3.628e⁻⁵ |
| S31 | 1.5427 | 7.383e⁻² | 1.383e⁻⁴ | 8.258e⁻⁴ | −1.265e⁻⁶ |
| S32 | −2.34e⁺³⁹ | 5.888e⁻² | 8.577e⁻⁴ | −8.893e⁻⁵ | 2.110e⁻⁵ |
| S61 | −4.3652 | −3.447e⁻² | 4.830e⁻³ | −6.022e⁻⁴ | 2.797e⁻⁵ |
| S62 | −3.12e⁺³⁹ | −9.120e⁻³ | 1.999e⁻³ | −2.110e⁻⁴ | 9.406e⁻⁶ |

TABLE 9

| State | D1 | D2 | D3 |
|---|---|---|---|
| Wide-angle end state (mm) | 0.2508 | 4.0860 | 0.0200 |
| Intermediate state (mm) | 0.5173 | 3.6108 | 0.5878 |
| Telephoto end state (mm) | 0.7290 | 3.1223 | 1.3227 |

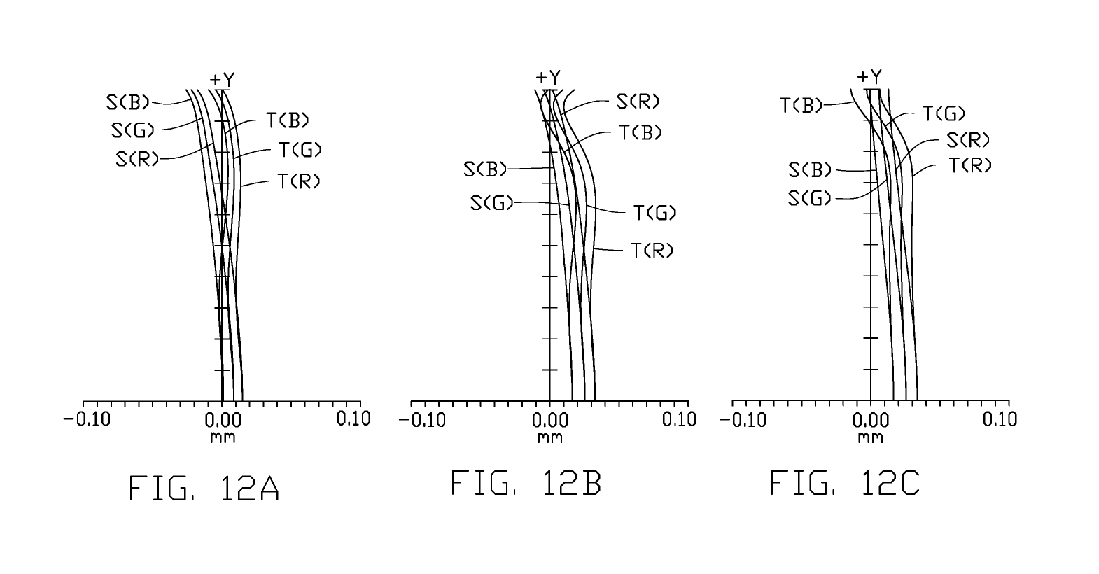

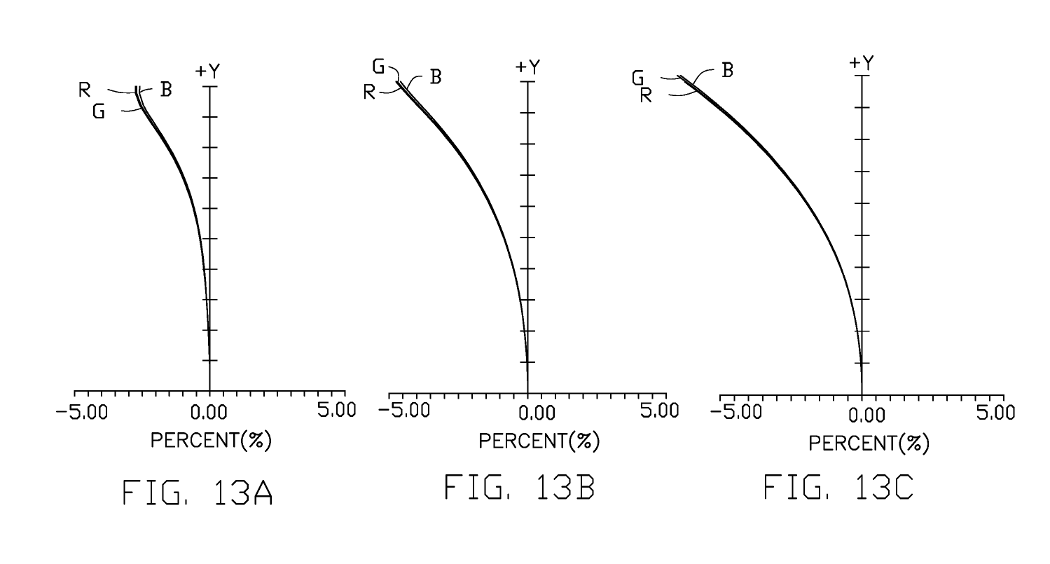

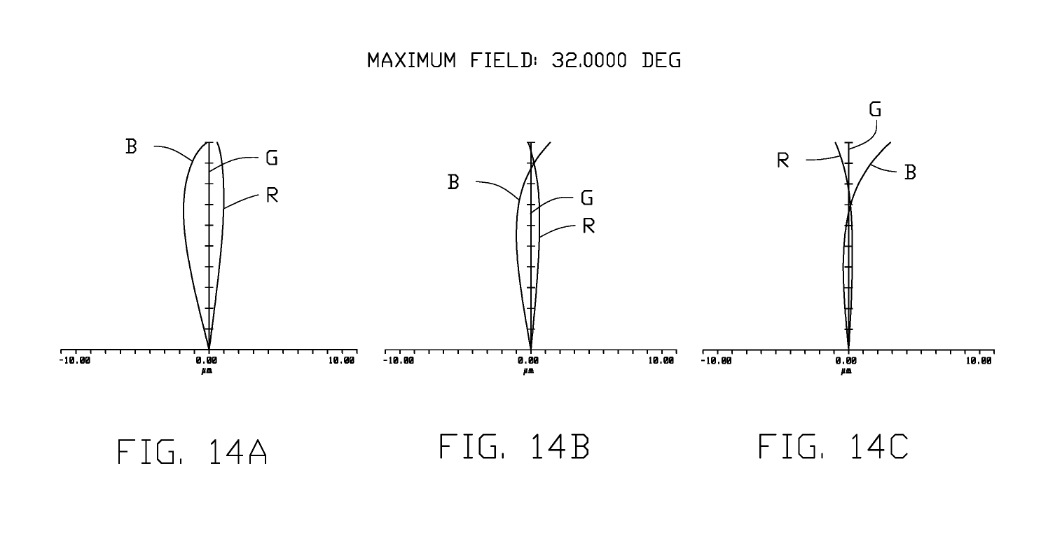

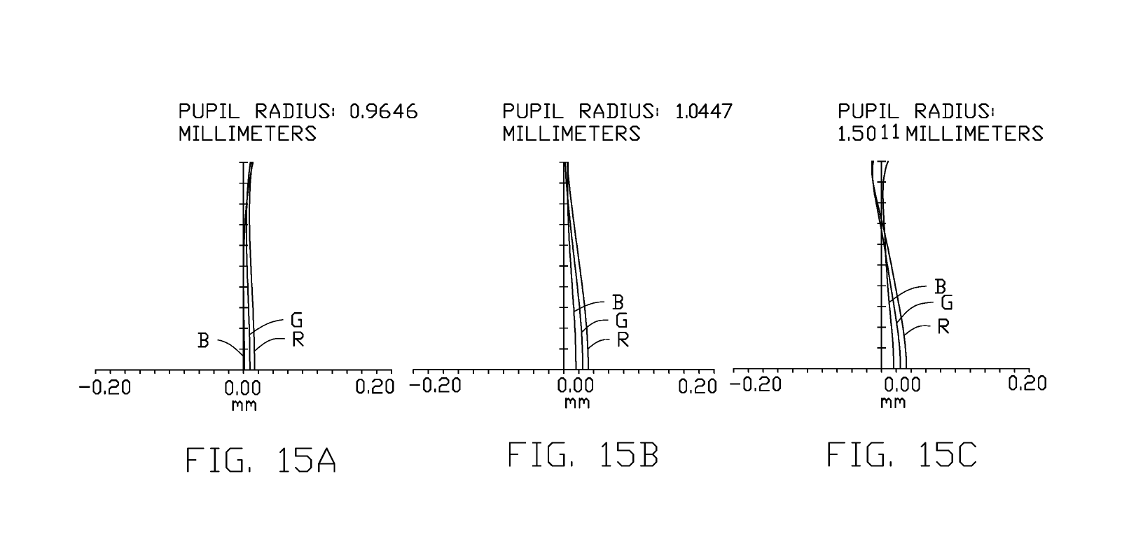

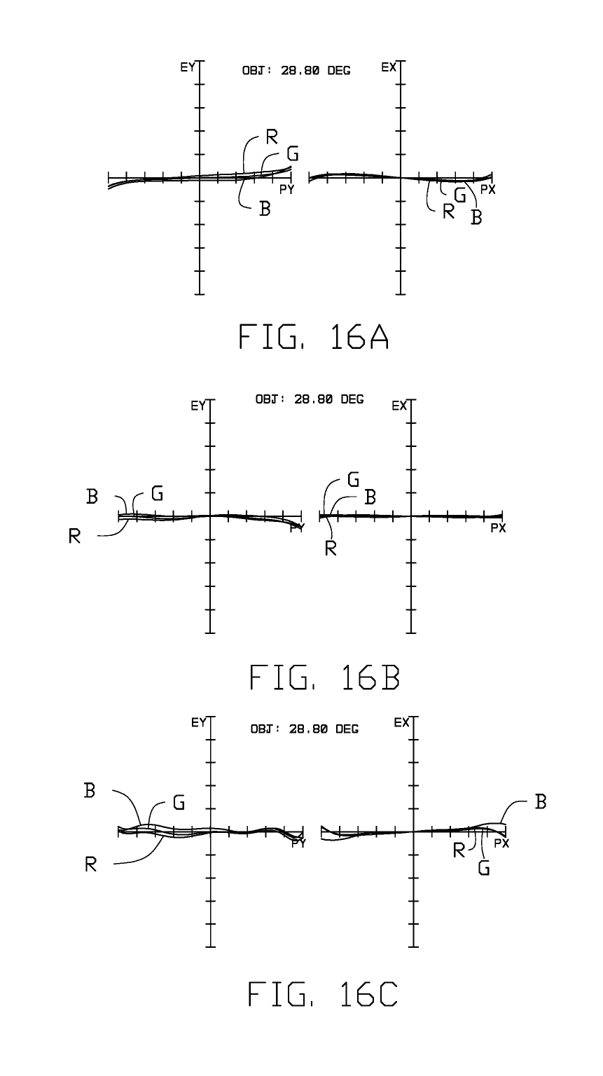

In the example 3, the respective field curvatures of the blue light, the green light, and the red light at the wide-angle end state, in the intermediate state, and at the telephoto end state are respectively shown in the FIGS. 12A, 12B, and 12C. The respective distortions of the blue light, the green light, and the red light at the wide-angle end state, in the intermediate state, and at the telephoto end state are respectively shown in the FIGS. 13A, 13B, and 13C. The respective lateral chromatic aberrations of the blue light, the green light, and the red light at the wide-angle end state, in the intermediate state, and at the telephoto end state are respectively shown in the FIGS. 14A, 14B, and 14C. The respective spherical aberrations of the blue light, the green light, and the red light at the wide-angle end state, in the intermediate state, and at the telephoto end state are respectively shown in the FIGS. 15A, 15B, and 15C. The respective coma aberrations of the blue light, the green light, and the red light at the wide-angle end state, in the intermediate state, and at the telephoto end state are respectively shown in the FIGS. 16A, 16B, and 16C.

Referring to FIG. 12A, the highest field curvature of the zoom lens 100 at the wide-angle end state is in a range from about −0.026 mm to about 0.015 mm. Referring to FIG. 13A, the highest distortion of the zoom lens 100 at the wide-angle end state is no more than −2.8%. Referring to FIG. 14A, the highest lateral chromatic aberration of the zoom lens 100 at the wide-angle end state is no more than 1.8 m. Referring to FIG. 15A, the highest spherical aberration of the zoom lens 100 at the wide-angle end state is in a range from about 0.013 mm to about 0.015 mm. Referring to FIG. 16A, the coma aberration of the zoom lens 100 at the wide-angle end state is acceptable.

Referring to FIG. 12B, the highest field curvature of the zoom lens 100 in the intermediate state is in a range from about −0.011 mm to about 0.034 mm. Referring to FIG. 13B, the highest distortion of the zoom lens 100 in the intermediate state is no more than −4.8%. Referring to FIG. 14B, the highest lateral chromatic aberration of the zoom lens 100 in the intermediate state is no more than 1.0 m. Referring to FIG. 15B, the highest spherical aberration of the zoom lens 100 in the intermediate state is in a range from about 0.002 mm to about 0.033 mm. Referring to FIG. 16B, the coma aberration of the zoom lens 100 in the intermediate state is acceptable.

Referring to FIG. 12C, the highest field curvature of the zoom lens 100 at the telephoto end state is in a range from about −0.015 mm to about 0.034 mm. Referring to FIG. 13C, the highest distortion of the zoom lens 100 at the telephoto end state is no more than −6.6%. Referring to FIG. 14C, the highest lateral chromatic aberration of the zoom lens 100 at the telephoto end state is no more than 2.9 m. Referring to FIG. 15C, the highest spherical aberration of the zoom lens 100 at the telephoto end state is in a range from about −0.014 mm to about 0.034 mm. Referring to FIG. 16C, the coma aberration of the zoom lens 100 at the telephoto end state is acceptable.

FIG. 17 illustrates an image device 200 including a main body 201 and a zoom lens 100 secured to the main body 201.

The embodiments shown and described above are only examples. Even though numerous characteristics and advantages of the present technology have been set forth in the foregoing description, together with details of the structures and functions of the present disclosure, the disclosure is illustrative only, and changes can be made in the detail, including in matters of shape, size, and arrangement of the parts within the principles of the present disclosure, up to and including, the full extent established by the broad general meaning of the terms used in the claims.

What is claimed is:

1. A zoom lens comprising:
a first lens group having a negative refractive power, and comprising a first lens having a positive refractive power and a second lens having a negative refractive power;
a second lens group having a positive refractive power;
a third lens group having a negative refractive power; and
an image plane;
wherein the first lens group, the second lens group, the third lens group, and the image plane are arranged in that order from object side to image side of the zoom lens, the first lens and the second lens are arranged in the order from the object side to the image side.

2. The zoom lens of claim 1, wherein the zoom lens satisfies the following formulas:
θ_{w}/TTL>8,

|FG1/f_{w}|≧4, and

|f₁/f₂|≧8.5,
wherein θ_{w} represents a field of view of the zoom lens at the wide-angle end state, TTL represents a total distance from the object side of the zoom lens to the image plane, FG1 represents a focal length of the first lens group, and f_{w} represents a focal length of the zoom lens at the wide-angle end state.

3. The zoom lens of claim 1, wherein the second lens group comprises a third lens having a positive refractive power, a fourth lens having a negative refractive power, and a fifth lens having a positive refractive power; the third lens, the fourth lens, and the fifth lens are arranged in the order written along the direction from an object side to an image side.

4. The zoom lens of claim 3, wherein the fourth lens and the fifth lens are fixed together to form a cemented lens.

5. The zoom lens of claim 3, wherein the zoom lens satisfies the following formulas:

|N_{d}4−N_{d}5|>0.25, and
0.65<|f₄/V₄+f₅/V₅|<0.75,
wherein N_{d}4 represents a refractive index of the fourth lens, N_{d}5 represents a refractive index of the fifth lens, f₄ represents a focal length of the fourth lens, f₅ represents a focal length of the fifth lens, V₄ represents an Abbe number of the fourth lens, and V₅ represents an Abbe number of the fifth lens.

6. The zoom lens of claim 1, wherein the zoom lens further satisfies the following formulas:
1.9≦|(FG2−MG3)/FG3|≦2.3, and
0.28≦|FG2/f_{T}|≦0.33,
wherein FG2 represents a focal length of the second lens group, MG3 represents a moving distance of third lens group moving from the wide-angle end to the telephoto end, FG3 represents a focal length of the third lens group, and f_{T} represents a focal length of the zoom lens at the telephoto end state.

7. The zoom lens of claim 3, wherein the third lens group comprises a sixth lens having a negative refractive power.

8. The zoom lens of claim 1, wherein at least one of the lens of the first lens group is made of plastic, at least one of the lens of the second lens group is made of plastic, at least one of the lens of the third lens group is made of plastic.

9. The zoom lens of claim 1, wherein the first lens group comprises at least one aspherical surface, the second lens group comprises at least one aspherical surface, the third lens group comprises at least one aspherical surface.

10. The zoom lens of claim 1, wherein the zoom lens comprises an aperture and a plane lens, the aperture is located between the first lens group and the second lens group, the plane lens is located between the third lens group and the image plane.

11. An image device comprising:
a zoom lens comprising:
a first lens group having a negative refractive power, and comprising a first lens having a positive refractive power and a second lens having a negative refractive power;
a second lens group having a positive refractive power;
a third lens group having a negative refractive power; and
an image plane;
wherein the first lens group, the second lens group, the third lens group, and the image plane are arranged in that order from object side to image side of the zoom lens, the first lens and the second lens are arranged in the order from the object side to the image side.

12. The image device of claim 11, wherein the zoom lens satisfies the following formulas:
θ_{w}/TTL>8,

|FG1/f_{w}|≧4, and

|f₁/f₂|≧8.5,
wherein θ_{w} represents a field of view of the zoom lens at the wide-angle end state, TTL represents a total distance from the object side of the zoom lens to the image plane, FG1 represents a focal length of the first lens group, and f_{w} represents a focal length of the zoom lens at the wide-angle end state.

13. The image device of claim 11, wherein the second lens group comprises a third lens having a positive refractive power, a fourth lens having a negative refractive power, and a fifth lens having a positive refractive power; the third lens, the fourth lens, and the fifth lens are arranged in the order written along the direction from an object side to an image side.

14. The image device of claim 13, wherein the fourth lens and the fifth lens are fixed together to form a cemented lens.

15. The image device of claim 13, wherein the zoom lens satisfies the following formulas:

|N_{d}4−N_{d}5|>0.25, and
0.65<|f₄/V₄+f₅/V₅|<0.75,
wherein N_{d}4 represents a refractive index of the fourth lens, N_{d}5 represents a refractive index of the fifth lens, f₄ represents a focal length of the fourth lens, f₅ represents a focal length of the fifth lens, V₄ represents an Abbe number of the fourth lens, and V₅ represents an Abbe number of the fifth lens.

16. The image device of claim 11, wherein the zoom lens further satisfies the following formulas:
1.9≦|(FG2−MG3)/FG3|≦2.3, and
0.28≦|FG2/f_{T}|≦0.33,
wherein FG2 represents a focal length of the second lens group, MG3 represents a moving distance of third lens group moving from the wide-angle end to the telephoto end, FG3 represents a focal length of the third lens group, and f_{T} represents a focal length of the zoom lens at the telephoto end.

17. The image device of claim 13, wherein the third lens group comprises a sixth lens having a negative refractive power.

18. The image device of claim 11, wherein at least one of the lens of the first lens group is made of plastic, at least one of the lens of the second lens group is made of plastic, at least one of the lens of the third lens group is made of plastic.

19. The image device of claim 11, wherein the first lens group comprises at least one aspherical surface, the second lens group comprises at least one aspherical surface, the third lens group comprises at least one aspherical surface.

20. The image device of claim 11, wherein the zoom lens comprises an aperture and a plane lens, the aperture is located between the first lens group and the second lens group, the plane lens is located between the third lens group and the image plane.
